(19) United States
(12) Patent Application Publication
(10) Pub. No.: US 2024/0123615 A1
(43) Pub. Date: Apr. 18, 2024

(54) PERFORMANCE TESTING FOR MOBILE ROBOT TRAJECTORY PLANNERS

(71) Applicant: Five AI Limited, Cambridge (GB)

(72) Inventors: Iain Whiteside, Cambridge (GB); John Redford, Cambridge (GB); David Hyman, Cambridge (GB); Constantin Veretennicov, Cambridge (GB)

(73) Assignee: Five AI Limited, Cambridge (GB)

(21) Appl. No.: 18/277,029

(22) PCT Filed: Feb. 11, 2022
(86) PCT No.: PCT/EP2022/053413

§ 371 Date: Aug. 11, 2023

(30) Foreign Application Priority Data
Feb. 12, 2021 (GB) 2102006.0
Apr. 23, 2021 (GB) 2105838.3

(51) Int. Cl. B25J 9/16

(52) U.S. Cl. CPC B25J 9/1664; B25J 9/162

(57) ABSTRACT

A computer-implemented method of evaluating the performance of a trajectory planner for a mobile robot in a real or simulated scenario, comprises receiving scenario ground truth of the scenario, the scenario ground truth generated using the trajectory planner to control an ego agent of the scenario responsive to at least one scenario element of the scenario. One or more performance evaluation rules for the scenario and at least one activation condition for each performance evaluation rule are received. A test oracle processes the scenario ground truth to determine whether the activation condition of each performance evaluation rule is satisfied over multiple time steps of the scenario. Each performance evaluation rule is evaluated by the test oracle, to provide at least one test result, only when its activation condition is satisfied.

### TECHNICAL FIELD

The present disclosure pertains to methods for evaluating the performance of trajectory planners in real or simulated scenarios, and computer programs and systems for implementing the same. Such planners are capable of autonomously planning ego trajectories for fully/semi-autonomous vehicles or other forms of mobile robot. Example applications include ADS (Autonomous Driving System) and ADAS (Advanced Driver Assist System) performance testing.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors. An autonomous vehicle may be fully autonomous (in that it is designed to operate with no human supervision or intervention, at least in certain circumstances) or semi-autonomous. Semi-autonomous systems require varying levels of human oversight and intervention, such systems including Advanced Driver Assist Systems and level three Autonomous Driving Systems. There are different facets to testing the behaviour of the sensors and control systems aboard a particular autonomous vehicle, or a type of autonomous vehicle.

A “level 5” vehicle is one that can operate entirely autonomously in any circumstances, because it is always guaranteed to meet some minimum level of safety. Such a vehicle would not require manual controls (steering wheel, pedals etc.) at all.

By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required.

Safety is an increasing challenge as the level of autonomy increases and more responsibility shifts from human to machine. In autonomous driving, the importance of guaranteed safety has been recognized. Guaranteed safety does not necessarily imply zero accidents, but rather means guaranteeing that some minimum level of safety is met in defined circumstances. It is generally assumed this minimum level of safety must significantly exceed that of human drivers for autonomous driving to be viable.

According to Shalev-Shwartz et al. “On a Formal Model of Safe and Scalable Self-driving Cars” (2017), arXiv:1708.06374 (the RSS Paper), which is incorporated herein by reference in its entirety, human driving is estimated to cause of the order 10⁻⁶ severe accidents per hour. On the assumption that autonomous driving systems will need to reduce this by at least three order of magnitude, the RSS Paper concludes that a minimum safety level of the order of 10⁻⁹ severe accidents per hour needs to be guaranteed, noting that a pure data-driven approach would therefore require vast quantities of driving data to be collected every time a change is made to the software or hardware of the AV system.

The RSS paper provides a model-based approach to guaranteed safety. A rule-based Responsibility-Sensitive Safety (RSS) model is constructed by formalizing a small number of “common sense” driving rules:
“1. Do not hit someone from behind.
2. Do not cut-in recklessly.
3. Right-of-way is given, not taken.
4. Be careful of areas with limited visibility.
5. If you can avoid an accident without causing another one, you must do it.”

The RSS model is presented as provably safe, in the sense that, if all agents were to adhere to the rules of the RSS model at all times, no accidents would occur. The aim is to reduce, by several orders of magnitude, the amount of driving data that needs to be collected in order to demonstrate the required safety level.

A safety model (such as RSS) can be used as a basis for evaluating the quality of trajectories realized by an ego agent in a real or simulated scenario under the control of an autonomous system (stack). The stack is tested by exposing it to different scenarios, and evaluating the resulting ego trajectories for compliance with rules of the safety model (rules-based testing). A rules-based testing approach can also be applied to other facets of performance, such as comfort or progress towards a defined goal.

### SUMMARY

According to a first aspect herein, a computer-implemented method of evaluating the performance of a trajectory planner for a mobile robot in a real or simulated scenario, the method comprising: receiving scenario ground truth of the scenario, the scenario ground truth generated using the trajectory planner to control an ego agent of the scenario responsive to at least one scenario element of the scenario; receiving one or more performance evaluation rules for the scenario and at least one activation condition for each performance evaluation rule; and processing, by a test oracle, the scenario ground truth, to determine whether the activation condition of each performance evaluation rule is satisfied over multiple time steps of the scenario. Each performance evaluation rule is evaluated by the test oracle, to provide at least one test result, only when its activation condition is satisfied.

In the context of pass/fail rules, this provides a third ‘not applicable’ to which a rule can evaluate in a given time step. Particularly when evaluating a large volume of scenario data (typically generated in simulation, or a combination of simulation in testing), evaluating potentially complex rules over many time steps and many scenarios can require very significant computational resources. By ‘deactivating’ rules based on simpler activation conditions (that are cheaper to evaluate than the rules themselves), significant resources savings may be attained, in a way that is not detrimental to the end results. Indeed, the quality of the results may be improved, as a ‘not applicable’ (inactive) result is often more informative, because it distinguishes between a situation in which a rule is applicable and is passed/failed, and a situation where the rule is not naturally applicable. For example, in a junction scenario, a rule might be defined in relation to various distance thresholds relative to multiple other agents on a road that an ego agent wishes to join, and only be activated when the ego agent crosses the boundary of the road. If the rule were instead active all of the time, not only could this be expensive to evaluate when the ego agent is waiting at the junction, but the results in that period would not be very informative (compared to the situation where, say, no distinction is made between ‘pass’ and ‘mot applicable’).

In embodiments, the scenario ground truth may be processed to determine whether the activation condition of each performance evaluation rule is satisfied over multiple time steps of the scenario for each scenario element of a set of multiple scenario elements. Each performance evaluation rule may be evaluated only when its activation condition is satisfied for at least one of the scenario elements, and only between the ego agent and the scenario element(s) for which the activation condition is satisfied.

In embodiments, each performance evaluation rule may be encoded in a piece of rule creation code as a second logic predicate and its activation condition is encoded therein as a first logic predicate, wherein at each time step, the test oracle evaluates the first logic predicate for each scenario element, and only evaluates the second logic predicate between the ego agent and any scenario element satisfying the first logic predicate.

Multiple performance evaluation rules, having different respective activation conditions, may be received and selectively evaluated by the test oracle according to their different respective activation conditions.

Each performance evaluation rule may pertain to driving performance.

The method may comprise rendering on a graphical user interface (GUI) respective results for the multiple time steps in a time-series, the result at each time step visually indicating one category of at least three categories comprising: a first category when the activation condition is not satisfied, a second category when the activation condition is satisfied and the rule is passed, and a third category when the activation condition is satisfied and the rule is failed.

For example, the result may be rendered as one colour of at least three different colours corresponding to the at least three categories.

The activation condition of a first performance evaluation rule of the performance evaluation rules may be dependent on the activation condition of at least a second performance evaluation rule of the performance evaluation rules.

For example, the first performance evaluation rule (e.g. pertaining to comfort) may be deactivated when the second performance evaluation rule (e.g. pertaining to safety) is active.

The scenario elements may comprise one or more other agents.

At least one of the performance evaluation rules may be selectively evaluated pairwise between the ego agent one scenario element of a set of scenario elements in the scenario, and its activation condition may be evaluated independently for each scenario element to determine whether to evaluate the performance evaluation rule between the ego agent and that other agent at each time step.

The set of scenario elements may be a set of other agents.

The activation condition may be evaluated for each scenario element to compute, at each time step, an iterable containing identifier of any scenario elements for which the activation condition is satisfied, and the performance evaluation rule may be evaluated by looping over the iterable at each time step.

The performance evaluation rule may be defined as a computational graph applied to one or more signals extracted from the scenario ground truth, with the iterable being passed through the computational graph in order to evaluate the rule between the ego agent any scenario element satisfying the activation condition.

A further aspect herein provides a computer-implemented method of evaluating the performance of a trajectory planner for a mobile robot in a real or simulated scenario that comprises: receiving scenario ground truth of the scenario, the scenario ground truth generated using the trajectory planner to control an ego agent of the scenario responsive to one or more scenario elements of the scenario; receiving one or more performance evaluation rules for the scenario and at least one activation condition for each performance evaluation rule; and processing, by a test oracle, the scenario ground truth, to determine whether the activation condition of each performance evaluation rule is satisfied over multiple time steps of the scenario, for each scenario element; wherein each performance evaluation rule is evaluated by the test oracle, to provide at least one test result, only when its activation condition is satisfied for at least one of the scenario elements, and only between the ego agent and the scenario element(s) for which the activation condition is satisfied.

Further aspects provide a computer system comprising one or more computers configured to implement the method of the first aspect or any embodiment thereof, and executable program instructions for programming a computer system to implement the same.

### BRIEF DESCRIPTION OF FIGURES

For a better understanding of the present disclosure, and to show how embodiments of the same may be carried into effect, reference is made by way of example only to the following figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 2A shows further details of a possible implementation of the testing pipeline;

FIG. 3A shows an example of a rule tree evaluated within a test oracle;

FIG. 3B shows an example output of a node of a rule tree;

FIG. 4A shows an example of a rule tree to be evaluated within a test oracle;

FIG. 4B shows a second example of a rule tree evaluated on a set of scenario ground truth data;

FIG. 4C shows how rules may be selectively applied within a test oracle;

FIG. 5 shows a schematic block diagram of a visualization component for rendering a graphical user interface;

FIGS. 5A, 5B and 5C show different views available within a graphical user interface;

FIG. 6A shows a first instance of a cut-in scenario;

FIG. 6B shows an example oracle output for the first scenario instance;

FIG. 6C shows a second instance of a cut-in scenario;

FIG. 6D shows an example oracle output for the second scenario instance;

FIG. 7 shows an example of rule creation code in a domain specific language for defining rules to be applied by a test oracle; and

FIG. 8 shows a further example of a GUI view for rendering outputs of custom rule trees.

### DETAILED DESCRIPTION

The described embodiments provide a testing pipeline to facilitate rules-based testing of mobile robot stacks in real or simulated scenarios. Agent (actor) behaviour in real or simulated scenarios is evaluated by a test oracle based on defined performance evaluation rules. Such rules may evaluate different facets of safety. For example, a safety rule set may be defined to assess the performance of the stack against a particular safety standard, regulation or safety model (such as RSS), or bespoke rule sets may be defined for testing any aspect of performance. The testing pipeline is not limited in its application to safety, and can be used to test any aspects of performance, such as comfort or progress towards some defined goal. A rule editor allows performance evaluation rules to be defined or modified and passed to the test oracle.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

The term “stack” can also refer to individual sub-systems (sub-stacks) of the full stack, such as perception, prediction, planning or control stacks, which may be tested individually or in any desired combination. A stack can refer purely to software, i.e. one or more computer programs that can be executed on one or more general-purpose computer processors.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. An interactive scenario additionally includes one or more other agents (“external” agent(s), e.g. other vehicles, pedestrians, cyclists, animals etc.).

The following examples consider applications to autonomous vehicle testing. However, the principles apply equally to other forms of mobile robot.

Scenarios may be represented or defined at different levels of abstraction. More abstracted scenarios accommodate a greater degree of variation. For example, a “cut-in scenario” or a “lane change scenario” are examples of highly abstracted scenarios, characterized by a maneuver or behaviour of interest, that accommodate many variations (e.g. different agent starting locations and speeds, road layout, environmental conditions etc.). A “scenario run” refers to a concrete occurrence of an agent(s) navigating a physical context, optionally in the presence of one or more other agents. For example, multiple runs of a cut-in or lane change scenario could be performed (in the real-world and/or in a simulator) with different agent parameters (e.g. starting location, speed etc.), different road layouts, different environmental conditions, and/or different stack configurations etc. The terms “run” and “instance” are used interchangeably in this context.

In the following examples, the performance of the stack is assessed, at least in part, by evaluating the behaviour of the ego agent in the test oracle against a given set of performance evaluation rules, over the course of one or more runs. The rules are applied to “ground truth” of the (or each) scenario run which, in general, simply means an appropriate representation of the scenario run (including the behaviour of the ego agent) that is taken as authoritative for the purpose of testing. Ground truth is inherent to simulation; a simulator computes a sequence of scenario states, which is, by definition, a perfect, authoritative representation of the simulated scenario run. In a real-world scenario run, a “perfect” representation of the scenario run does not exist in the same sense; nevertheless, suitably informative ground truth can be obtained in numerous ways, e.g. based on manual annotation of on-board sensor data, automated/semi-automated annotation of such data (e.g. using offline/non-real time processing), and/or using external information sources (such as external sensors, maps etc.) etc.

The scenario ground truth typically includes a “trace” of the ego agent and any other (salient) agent(s) as applicable. A trace is a history of an agent's location and motion over the course of a scenario. There are many ways a trace can be represented. Trace data will typically include spatial and motion data of an agent within the environment. The term is used in relation to both real scenarios (with real-world traces) and simulated scenarios (with simulated traces). The trace typically records an actual trajectory realized by the agent in the scenario. With regards to terminology, a “trace” and a “trajectory” may contain the same or similar types of information (such as a series of spatial and motion states over time). The term trajectory is generally favoured in the context of planning (and can refer to future/predicted trajectories), whereas the term trace is generally favoured in relation to past behaviour in the context of testing/evaluation.

In a simulation context, a “scenario description” is provided to a simulator as input. For example, a scenario description may be encoded using a scenario description language (SDL), or in any other form that can be consumed by a simulator. A scenario description is typically a more abstract representation of a scenario, that can give rise to multiple simulated runs. Depending on the implementation, a scenario description may have one or more configurable parameters that can be varied to increase the degree of possible variation. The degree of abstraction and parameterization is a design choice. For example, a scenario description may encode a fixed layout, with parameterized environmental conditions (such as weather, lighting etc.). Further abstraction is possible, however, e.g. with configurable road parameter(s) (such as road curvature, lane configuration etc.). The input to the simulator comprises the scenario description together with a chosen set of parameter value(s) (as applicable). The latter may be referred to as a parameterization of the scenario. The configurable parameter(s) define a parameter space (also referred to as the scenario space), and the parameterization corresponds to a point in the parameter space. In this context, a “scenario instance” may refer to an instantiation of a scenario in a simulator based on a scenario description and (if applicable) a chosen parameterization.

For conciseness, the term scenario may also be used to refer to a scenario run, as well a scenario in the more abstracted sense. The meaning of the term scenario will be clear from the context in which it is used.

Trajectory planning is an important function in the present context, and the terms “trajectory planner”, “trajectory planning system” and “trajectory planning stack” may be used interchangeably herein to refer to a component or components that can plan trajectories for a mobile robot into the future. Trajectory planning decisions ultimately determine the actual trajectory realized by the ego agent (although, in some testing contexts, this may be influenced by other factors, such as the implementation of those decisions in the control stack, and the real or modelled dynamic response of the ego agent to the resulting control signals).

A trajectory planner may be tested in isolation, or in combination with one or more other systems (e.g. perception, prediction and/or control). Within a full stack, planning generally refers to higher-level autonomous decision-making capability (such as trajectory planning), whilst control generally refers to the lower-level generation of control signals for carrying out those autonomous decisions. However, in the context of performance testing, the term control is also used in the broader sense. For the avoidance of doubt, when a trajectory planner is said to control an ego agent in simulation, that does not necessarily imply that a control system (in the narrower sense) is tested in combination with the trajectory planner.

### Example AV Stack

To provide relevant context to the described embodiments, further details of an example form of AV stack will now be described.

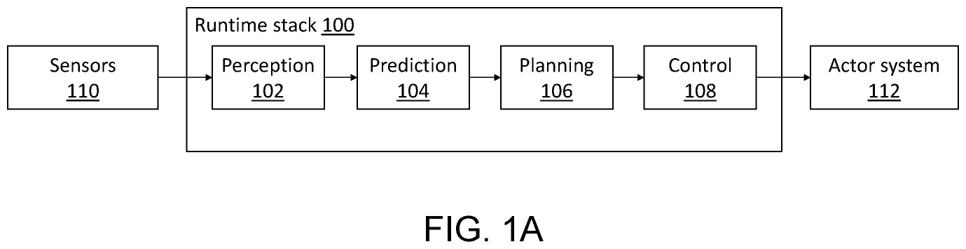

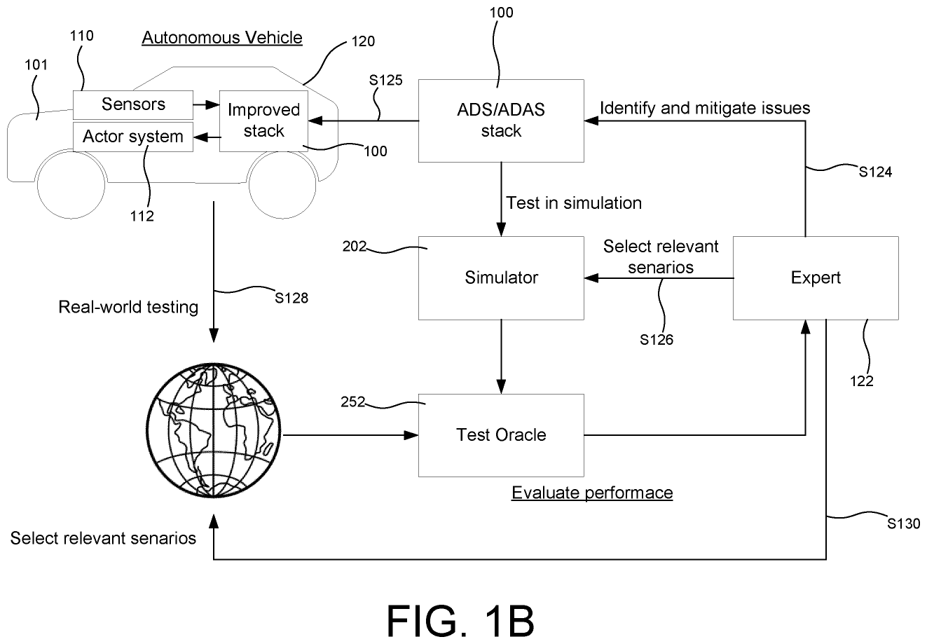

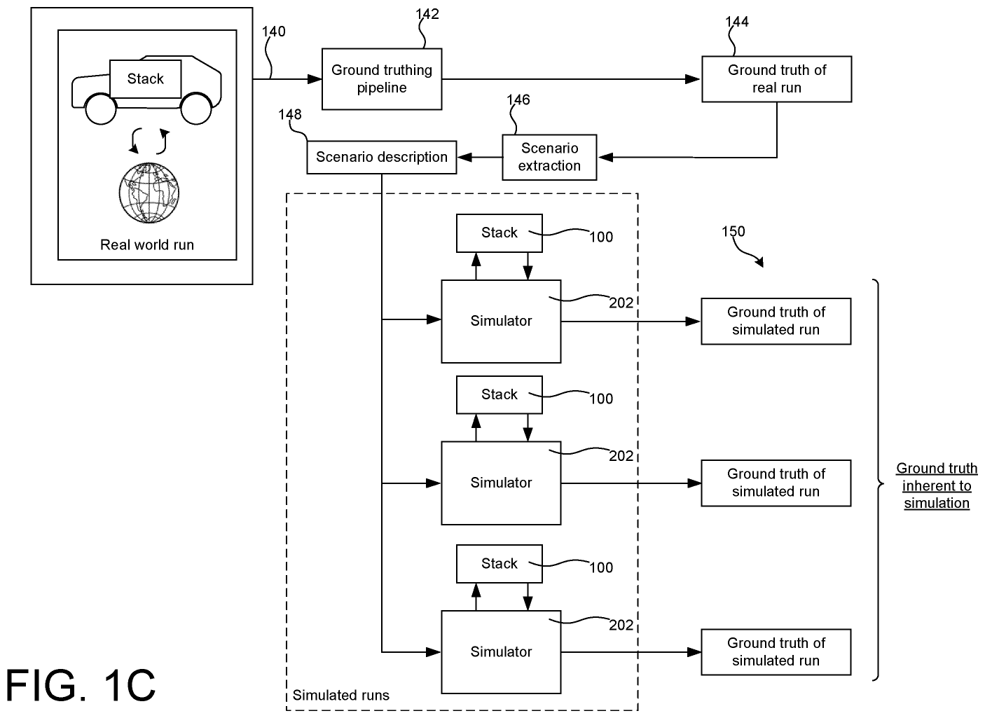

FIG. 1A shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. As noted, the term (sub-)stack may also be used to describe the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes). The planning system 106 may reason into the future, such that the planned trajectory at each planning step extends beyond the next planning step. Any individual planned trajectory may, therefore, not be fully realized (if the planning system 106 is tested in isolation, in simulation, the ego agent may simply follow the planned trajectory exactly up to the next planning step; however, as noted, in other real and simulation contexts, the planned trajectory may not be followed exactly up to the next planning step, as the behaviour of the ego agent could be influenced by other factors, such as the operation of the control system 108 and the real or modelled dynamics of the ego vehicle). In many testing contexts, the actual trajectory of the ego agent is what ultimately matters; in particular, whether the actual trajectory is safe, as well as other factors such as comfort and progress. However, the rules-based testing approach herein can also be applied to planned trajectories (even if those planned trajectories are not fully or exactly realized by the ego agent). For example, even if the actual trajectory of an agent is deemed safe according to a given set of safety rules, it might be that an instantaneous planned trajectory was unsafe; the fact that the planner 106 was considering an unsafe course of action may be revealing, even if it did not lead to unsafe agent behaviour in the scenario. Instantaneous planned trajectories constitute one form of internal state that can be usefully evaluated, in addition to actual agent behaviour in the simulation. Other forms of internal stack state can be similarly evaluated.

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

It will be appreciated that the term “stack” encompasses software, but can also encompass hardware. In simulation, software of the stack may be tested on a “generic” off-board computer system before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step 125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance though the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (trace(s) and contextual data) for the real-world run. As discussed, the ground-truthing process could be based on manual annotation of the ‘raw’ run data 142, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a more abstracted scenario description 148 that can be used for the purpose of simulation. The scenario description 148 is consumed by the simulator 202, allowing multiple simulated runs to be performed. The simulated runs are variations of the original real-world run, with the degree of possible variation determined by the extent of abstraction. Ground truth 150 is provided for each simulated run.

### Testing Pipeline

Further details of the testing pipeline and the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

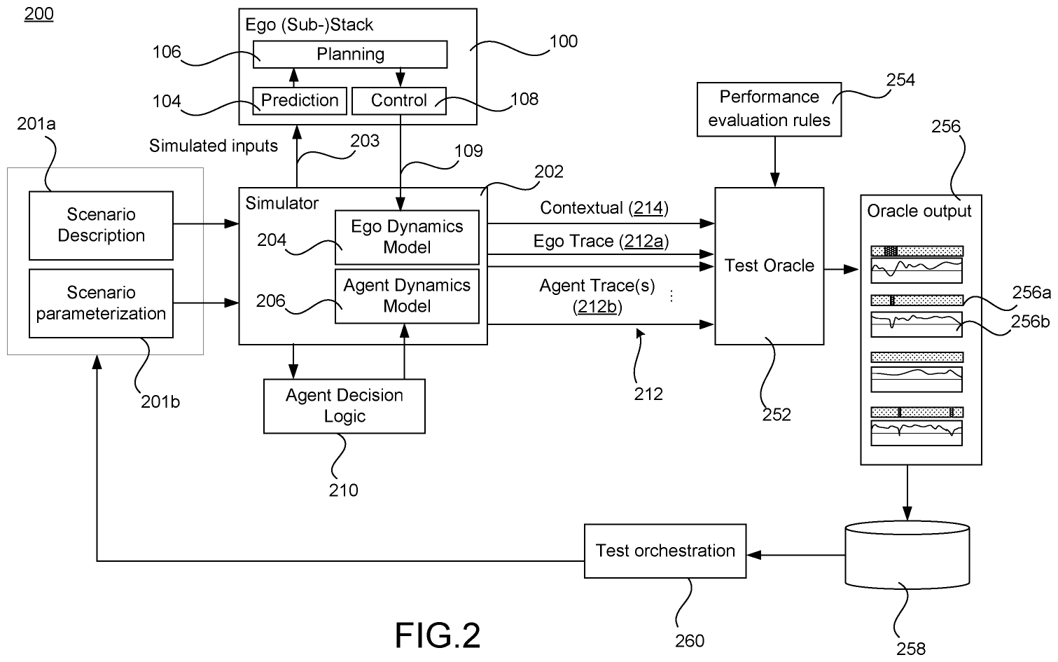

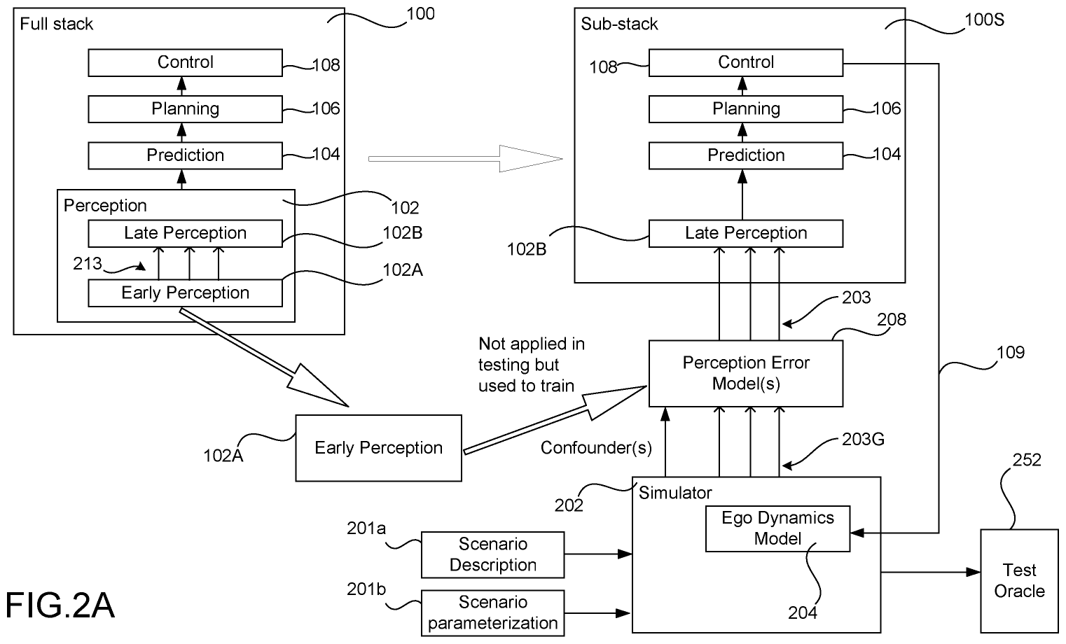

FIG. 2 shows a schematic block diagram of the testing pipeline, denoted by reference numeral 200. The testing pipeline 200 is shown to comprise the simulator 202 and the test oracle 252. The simulator 202 runs simulated scenarios for the purpose of testing all or part of an AV run time stack 100, and the test oracle 252 evaluates the performance of the stack (or sub-stack) on the simulated scenarios. As discussed, it may be that only a sub-stack of the run-time stack is tested, but for simplicity, the following description refers to the (full) AV stack 100 throughout. However, the description applies equally to a sub-stack in place of the full stack 100. The term “slicing” is used herein to the selection of a set or subset of stack components for testing.

As described previously, the idea of simulation-based testing is to run a simulated driving scenario that an ego agent must navigate under the control of the stack 100 being tested. Typically, the scenario includes a static drivable area (e.g. a particular static road layout) that the ego agent is required to navigate, typically in the presence of one or more other dynamic agents (such as other vehicles, bicycles, pedestrians etc.). To this end, simulated inputs 203 are provided from the simulator 202 to the stack 100 under testing.

The slicing of the stack dictates the form of the simulated inputs 203. By way of example, FIG. 2 shows the prediction, planning and control systems 104, 106 and 108 within the AV stack 100 being tested. To test the full AV stack of FIG. 1A, the perception system 102 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario (i.e. “perfect” predictions).

Between these extremes, there is scope for many different levels of input slicing, e.g. testing only a subset of the perception system 102, such as “later” (higher-level) perception components, e.g. components such as filters or fusion components which operate on the outputs from lower-level perception components (such as object detectors, bounding box detectors, motion detectors etc.).

Whatever form they take, the simulated inputs 203 are used (directly or indirectly) as a basis for decision-making by the planner 108. The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly between planning steps. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour if appropriate.

A scenario is run in accordance with a scenario description 201a and (if applicable) a chosen parameterization 201b of the scenario. A scenario typically has both static and dynamic elements which may be “hard coded” in the scenario description 201a or configurable and thus determined by the scenario description 201a in combination with a chosen parameterization 201b. In a driving scenario, the static element(s) typically include a static road layout.

The dynamic element(s) typically include one or more external agents within the scenario, such as other vehicles, pedestrians, bicycles etc.

The extent of the dynamic information provided to the simulator 202 for each external agent can vary. For example, a scenario may be described by separable static and dynamic layers. A given static layer (e.g. defining a road layout) can be used in combination with different dynamic layers to provide different scenario instances. The dynamic layer may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 210 might be permitted to reduce the speed of the external agent below the target at any point along the path in order to maintain a target headway from a forward vehicle.

As will be appreciated, scenarios can be described for the purpose of simulation in many ways, with any degree of configurability. For example, the number and type of agents, and their motion information may be configurable as part of the scenario parameterization 201b.

The output of the simulator 202 for a given simulation includes an ego trace 212a of the ego agent and one or more agent traces 212b of the one or more external agents (traces 212). Each trace 212a, 212b is a complete history of an agent's behaviour within a simulation having both spatial and motion components. For example, each trace 212a, 212b may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “contextual” data 214. The contextual data 214 pertains to the physical context of the scenario, and can have both static components (such as road layout) and dynamic components (such as weather conditions to the extent they vary over the course of the simulation). To an extent, the contextual data 214 may be “passthrough” in that it is directly defined by the scenario description 201a or the choice of parameterization 201b, and is thus unaffected by the outcome of the simulation. For example, the contextual data 214 may include a static road layout that comes from the scenario description 201a or the parameterization 201b directly. However, typically the contextual data 214 would include at least some elements derived within the simulator 202. This could, for example, include simulated environmental data, such as weather data, where the simulator 202 is free to change weather conditions as the simulation progresses. In that case, the weather data may be time-dependent, and that time dependency will be reflected in the contextual data 214.

The test oracle 252 receives the traces 212 and the contextual data 214, and scores those outputs in respect of a set of performance evaluation rules 254. The performance evaluation rules 254 are shown to be provided as an input to the test oracle 252.

The rules 254 are categorical in nature (e.g. pass/fail-type rules). Certain performance evaluation rules are also associated with numerical performance metrics used to “score” trajectories (e.g. indicating a degree of success or failure or some other quantity that helps explain or is otherwise relevant to the categorical results). The evaluation of the rules 254 is time-based—a given rule may have a different outcome at different points in the scenario. The scoring is also time-based: for each performance evaluation metric, the test oracle 252 tracks how the value of that metric (the score) changes over time as the simulation progresses. The test oracle 252 provides an output 256 comprising a time sequence 256a of categorical (e.g. pass/fail) results for each rule, and a score-time plot 256b for each performance metric, as described in further detail later. The results and scores 256a, 256b are informative to the expert 122 and can be used to identify and mitigate performance issues within the tested stack 100. The test oracle 252 also provides an overall (aggregate) result for the scenario (e.g. overall pass/fail). The output 256 of the test oracle 252 is stored in a test database 258, in association with information about the scenario to which the output 256 pertains. For example, the output 256 may be stored in association with the scenario description 210a (or an identifier thereof), and the chosen parameterization 201b. As well as the time-dependent results and scores, an overall score may also be assigned to the scenario and stored as part of the output 256. For example, an aggregate score for each rule (e.g. overall pass/fail) and/or an aggregate result (e.g. pass/fail) across all of the rules 254.

FIG. 2A illustrates another choice of slicing and uses reference numerals 100 and 100S to denote a full stack and sub-stack respectively. It is the sub-stack 100S that would be subject to testing within the testing pipeline 200 of FIG. 2.

A number of “later” perception components 102B form part of the sub-stack 100S to be tested and are applied, during testing, to simulated perception inputs 203. The later perception components 102B could, for example, include filtering or other fusion components that fuse perception inputs from multiple earlier perception components.

In the full stack 100, the later perception components 102B would receive actual perception inputs 213 from earlier perception components 102A. For example, the earlier perception components 102A might comprise one or more 2D or 3D bounding box detectors, in which case the simulated perception inputs provided to the late perception components could include simulated 2D or 3D bounding box detections, derived in the simulation via ray tracing. The earlier perception components 102A would generally include component(s) that operate directly on sensor data. With the slicing of FIG. 2A, the simulated perception inputs 203 would correspond in form to the actual perception inputs 213 that would normally be provided by the earlier perception components 102A. However, the earlier perception components 102A are not applied as part of the testing, but are instead used to train one or more perception error models 208 that can be used to introduce realistic error, in a statistically rigorous manner, into the simulated perception inputs 203 that are fed to the later perception components 102B of the sub-stack 100 under testing.

Such perception error models may be referred to as Perception Statistical Performance Models (PSPMs) or, synonymously, “PRISMs”. Further details of the principles of PSPMs, and suitable techniques for building and training them, may be bound in International Patent Publication Nos. WO2021037763 WO2021037760, WO2021037765, WO2021037761, and WO2021037766, each of which is incorporated herein by reference in its entirety. The idea behind PSPMs is to efficiently introduce realistic errors into the simulated perception inputs provided to the sub-stack 100S (i.e. that reflect the kind of errors that would be expected were the earlier perception components 102A to be applied in the real-world). In a simulation context, “perfect” ground truth perception inputs 203G are provided by the simulator, but these are used to derive more realistic perception inputs 203 with realistic error introduced by the perception error models(s) 208.

As described in the aforementioned reference, a PSPM can be dependent on one or more variables representing physical condition(s) (“confounders”), allowing different levels of error to be introduced that reflect different possible real-world conditions. Hence, the simulator 202 can simulate different physical conditions (e.g. different weather conditions) by simply changing the value of a weather confounder(s), which will, in turn, change how perception error is introduced.

The later perception components 102b within the sub-stack 1005 process the simulated perception inputs 203 in exactly the same way as they would process the real-world perception inputs 213 within the full stack 100, and their outputs, in turn, drive prediction, planning and control.

Alternatively, PRISMs can be used to model the entire perception system 102, including the late perception components 208, in which case a PSPM(s) is used to generate realistic perception output that are passed as inputs to the prediction system 104 directly.

Depending on the implementation, there may or may not be deterministic relationship between a given scenario parameterization 201b and the outcome of the simulation for a given configuration of the stack 100 (i.e. the same parameterization may or may not always lead to the same outcome for the same stack 100). Non-determinism can arise in various ways. For example, when simulation is based on PRISMs, a PRISM might model a distribution over possible perception outputs at each given time step of the scenario, from which a realistic perception output is sampled probabilistically. This leads to non-deterministic behaviour within the simulator 202, whereby different outcomes may be obtained for the same stack 100 and scenario parameterization because different perception outputs are sampled. Alternatively, or additionally, the simulator 202 may be inherently non-deterministic, e.g. weather, lighting or other environmental conditions may be randomized/probabilistic within the simulator 202 to a degree. As will be appreciated, this is a design choice: in other implementations, varying environmental conditions could instead be fully specified in the parameterization 201b of the scenario. With non-deterministic simulation, multiple scenario instances could be run for each parameterization. An aggregate pass/fail result could be assigned to a particular choice of parameterization 201b, e.g. as a count or percentage of pass or failure outcomes.

A test orchestration component 260 is responsible for selecting scenarios for the purpose of simulation. For example, the test orchestration component 260 may select scenario descriptions 201a and suitable parameterizations 201b automatically, based on the test oracle outputs 256 from previous scenarios.

### Test Oracle Rules:

The performance evaluation rules 254 are constructed as computational graphs (rule trees) to be applied within the test oracle. Unless otherwise indicated, the term “rule tree” herein refers to the computational graph that is configured to implement a given rule. Each rule is constructed as a rule tree, and a set of multiple rules may be referred to as a “forest” of multiple rule trees.

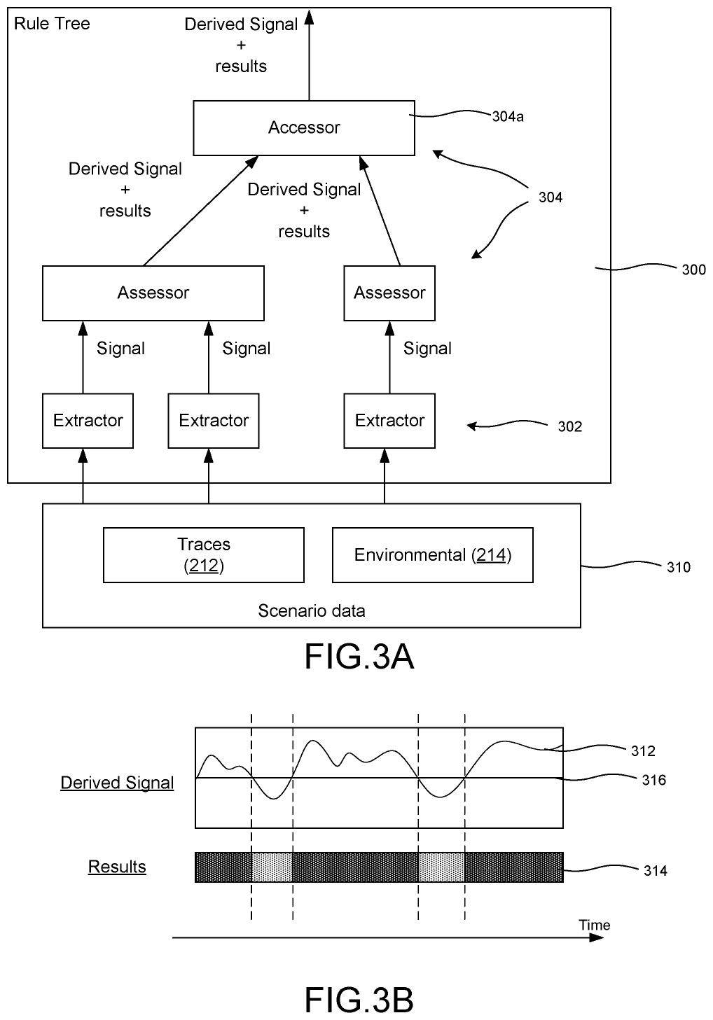

FIG. 3A shows an example of a rule tree 300 constructed from a combination of extractor nodes (leaf objects) 302 and assessor nodes (non-leaf objects) 304. Each extractor node 302 extracts a time-varying numerical (e.g. floating point) signal (score) from a set of scenario data 310. The scenario data 310 is a form of scenario ground truth, in the sense laid out above, and may be referred to as such. The scenario data 310 has been obtained by deploying a trajectory planner (such as the planner 106 of FIG. 1A) in a real or simulated scenario, and is shown to comprise ego and agent traces 212 as well as contextual data 214. In the simulation context of FIG. 2 or FIG. 2A, the scenario ground truth 310 is provided as an output of the simulator 202.

Each assessor node 304 is shown to have at least one child object (node), where each child object is one of the extractor nodes 302 or another one of the assessor nodes 304. Each assessor node receives output(s) from its child node(s) and applies an assessor function to those output(s). The output of the assessor function is a time-series of categorical results. The following examples consider simple binary pass/fail results, but the techniques can be readily extended to non-binary results. Each assessor function assesses the output(s) of its child node(s) against a predetermined atomic rule. Such rules can be flexibly combined in accordance with a desired safety model.

In addition, each assessor node 304 derives a time-varying numerical signal from the output(s) of its child node(s), which is related to the categorical results by a threshold condition (see below).

A top-level root node 304a is an assessor node that is not a child node of any other node. The top-level node 304a outputs a final sequence of results, and its descendants (i.e. nodes that are direct or indirect children of the top-level node 304a) provide the underlying signals and intermediate results.

FIG. 3B visually depicts an example of a derived signal 312 and a corresponding time-series of results 314 computed by an assessor node 304. The results 314 are correlated with the derived signal 312, in that a pass result is returned when (and only when) the derived signal exceeds a failure threshold 316. As will be appreciated, this is merely one example of a threshold condition that relates a time-sequence of results to a corresponding signal.

Signals extracted directly from the scenario ground truth 310 by the extractor nodes 302 may be referred to as “raw” signals, to distinguish from “derived” signals computed by assessor nodes 304. Results and raw/derived signals may be discretized in time.

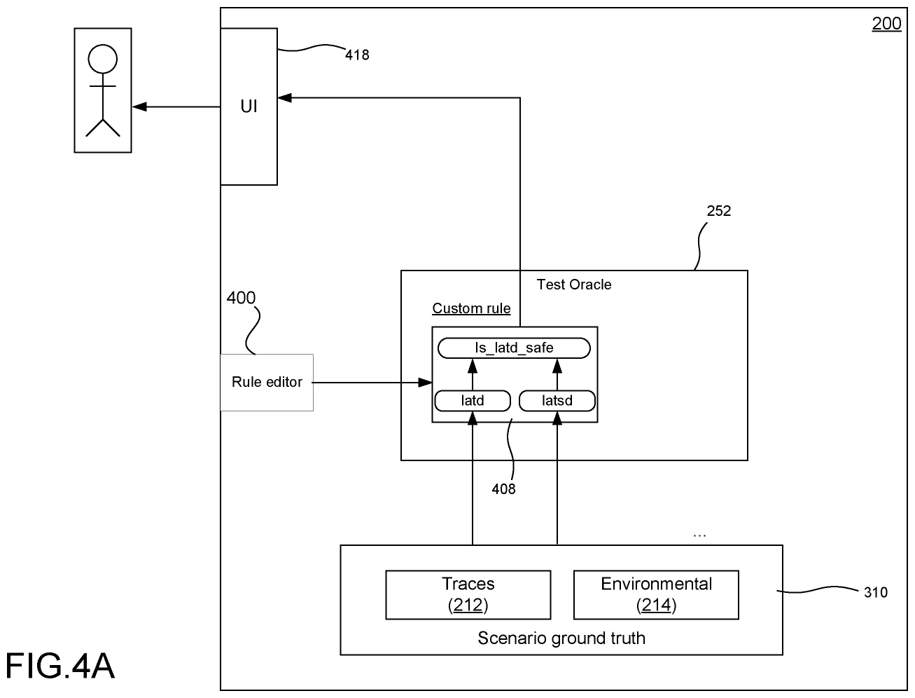

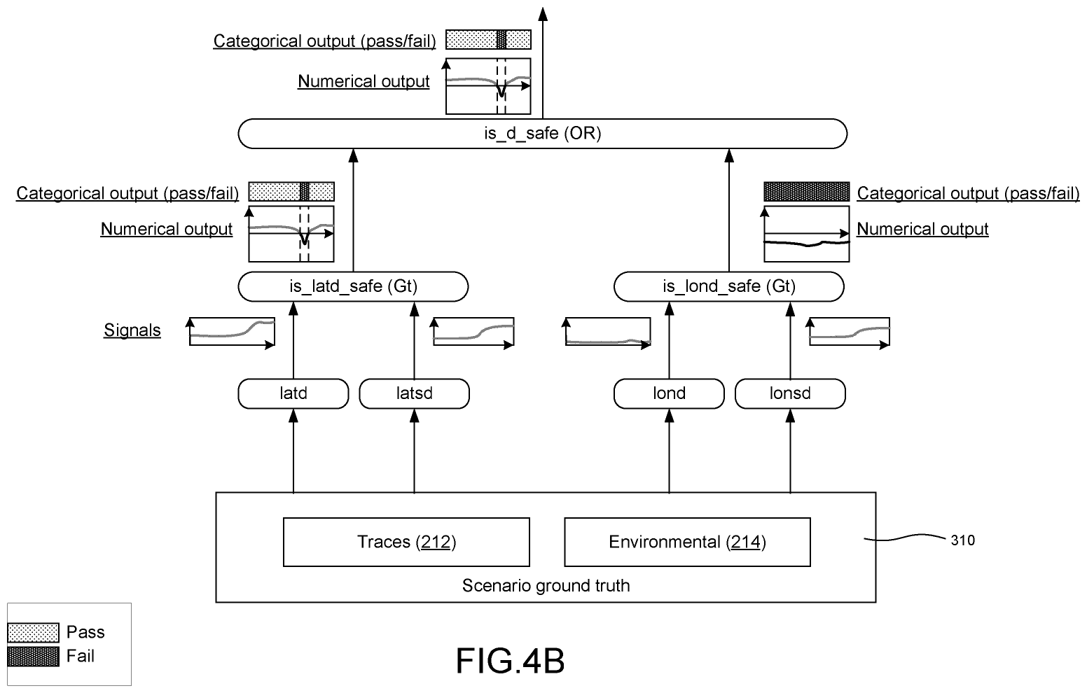

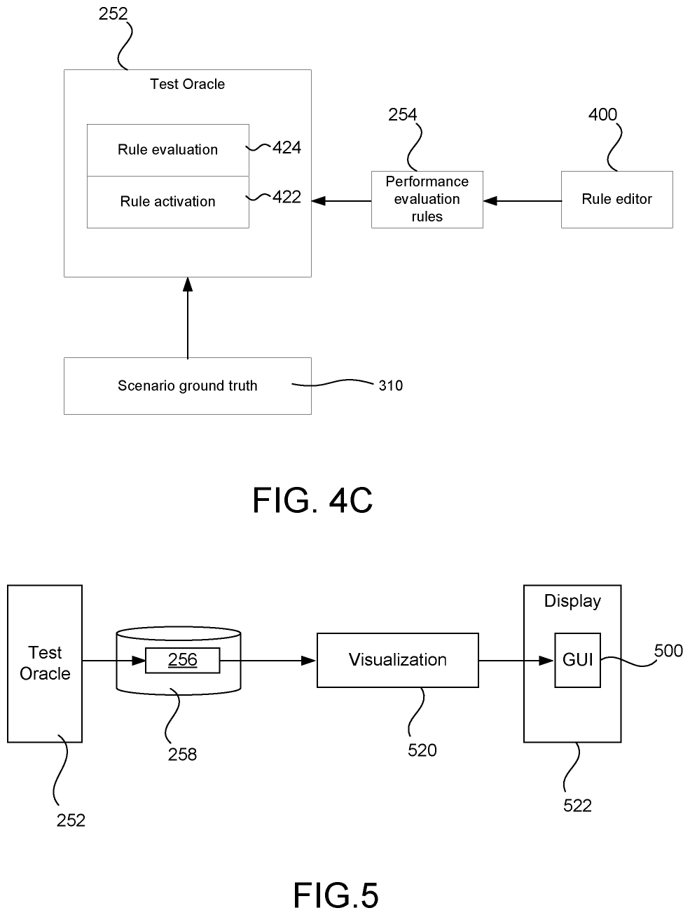

FIG. 4A shows an example of a rule tree implemented within the testing platform 200.

A rule editor 400 is provided for constructing rules to be implemented with the test oracle 252. The rule editor 400 receives rule creation inputs from a user (who may or may not be the end-user of the system). In the present example, the rule creation inputs are coded in a domain specific language (DSL) and define at least one rule graph 408 to be implemented within the test oracle 252. The rules are logical rules in the following examples, with TRUE and FALSE representing pass and failure respectively (as will be appreciated, this is purely a design choice).

The following examples consider rules that are formulated using combinations of atomic logic predicates. Examples of basic atomic predicates include elementary logic gates (OR, AND etc.), and logical functions such as “greater than”, (Gt(a,b)) (which returns TRUE when a is greater than b, and false otherwise).

A Gt function is to implement a safe lateral distance rule between an ego agent and another agent in the scenario (having agent identifier “other_agent_id”). Two extractor nodes (latd, latsd) apply LateralDistance and LateralSafeDistance extractor functions respectively. Those functions operate directly on the scenario ground truth 310 to extract, respectively, a time-varying lateral distance signal (measuring a lateral distance between the ego agent and the identified other agent), and a time-varying safe lateral distance signal for the ego agent and the identified other agent. The safe lateral distance signal could depend on various factors, such as the speed of the ego agent and the speed of the other agent (captured in the traces 212), and environmental conditions (e.g. weather, lighting, road type etc.) captured in the contextual data 214.

An assessor node (is_latd_safe) is a parent to the latd and latsd extractor nodes, and is mapped to the Gt atomic predicate. Accordingly, when the rule tree 408 is implemented, the is_latd_safe assessor node applies the Gt function to the outputs of the latd and latsd extractor nodes, in order to compute a true/false result for each timestep of the scenario, returning TRUE for each time step at which the latd signal exceeds the latsd signal and FALSE otherwise. In this manner, a “safe lateral distance” rule has been constructed from atomic extractor functions and predicates; the ego agent fails the safe lateral distance rule when the lateral distance reaches or falls below the safe lateral distance threshold. As will be appreciated, this is a very simple example of a rule tree. Rules of arbitrary complexity can be constructed according to the same principles.

The test oracle 252 applies the rule tree 408 to the scenario ground truth 310, and provides the results via a user interface (UI) 418.

FIG. 4B shows an example of a rule tree that includes a lateral distance branch corresponding to that of FIG. 4A. Additionally, the rule tree includes a longitudinal distance branch, and a top-level OR predicate (safe distance node, is_d_safe) to implement a safe distance metric. Similar to the lateral distance branch, the longitudinal distance brand extracts longitudinal distance and longitudinal distance threshold signals from the scenario data (extractor nodes lond and lonsd respectively), and a longitudinal safety assessor node (is_lond_safe) returns TRUE when the longitudinal distance is above the safe longitudinal distance threshold. The top-level OR node returns TRUE when one or both of the lateral and longitudinal distances is safe (below the applicable threshold), and FALSE if neither is safe. In this context, it is sufficient for only one of the distances to exceed the safety threshold (e.g. if two vehicles are driving in adjacent lanes, their longitudinal separation is zero or close to zero when they are side-by-side; but that situation is not unsafe if those vehicles have sufficient lateral separation).

The numerical output of the top-level node could, for example, be a time-varying robustness score.

Different rule trees can be constructed, e.g. to implement different rules of a given safety model, to implement different safety models, or to apply rules selectively to different scenarios (in a given safety model, not every rule will necessarily be applicable to every scenario; with this approach, different rules or combinations of rules can be applied to different scenarios). Within this framework, rules can also be constructed for evaluating comfort (e.g. based on instantaneous acceleration and/or jerk along the trajectory), progress (e.g. based on time taken to reach a defined goal) etc.

The above examples consider simple logical predicates evaluated on results or signals at a single time instance, such as OR, AND, Gt etc. However, in practice, it may be desirable to formulate certain rules in terms of temporal logic.

Hekmatnejad et al., “Encoding and Monitoring Responsibility Sensitive Safety Rules for Automated Vehicles in Signal Temporal Logic” (2019), MEMOCODE '19: Proceedings of the 17th ACM-IEEE International Conference on Formal Methods and Models for System Design (incorporated herein by reference in its entirety) discloses a signal temporal logic (STL) encoding of the RSS safety rules. Temporal logic provides a formal framework for constructing predicates that are qualified in terms of time. This means that the result computed by an assessor at a given time instant can depend on results and/or signal values at another time instant(s).

For example, a requirement of the safety model may be that an ego agent responds to a certain event within a set time frame. Such rules can be encoded in a similar manner, using temporal logic predicates within the rule tree.

In the above examples, the performance of the stack 100 is evaluated at each time step of a scenario. An overall test result (e.g. pass/fail) can be derived from this—for example, certain rules (e.g. safety-critical rules) may result in an overall failure if the rule is failed at any time step within the scenario (that is, the rule must be passed at every time step to obtain an overall pass on the scenario). For other types of rule, the overall pass/fail criteria may be “softer” (e.g. failure may only be triggered for a certain rule if that rule is failed over some number of sequential time steps), and such criteria may be context dependent.

FIG. 4C schematically depicts a hierarchy of rule evaluation implemented within the test oracle 252. A set of rules 254 is received for implementation in the test oracle 252.

Certain rules apply only to the ego agent (an example being a comfort rule that assesses whether or not some maximum acceleration or jerk threshold is exceeded by the ego trajectory at any given time instant).

Other rules pertain to the interaction of the ego agent with other agents (for example, a “no collision” rule or the safe distance rule considered above). Each such rule is evaluated in a pairwise fashion between the ego agent and each other agent. As another example, a “pedestrian emergency braking” rule may only be activated when a pedestrian walks out in front of the ego vehicle, and only in respect of that pedestrian agent.

Not every rule will necessarily be applicable to every scenario, and some rules may only be applicable for part of a scenario. Rule activation logic 422 within the test oracle 422 determines if and when each of the rules 254 is applicable to the scenario in question, and selectively activates rules as and when they apply. A rule may, therefore, remain active for the entirety of a scenario, may never be activated for a given scenario, or may be activated for only some of the scenario. Moreover, a rule may be evaluated for different numbers of agents at different points in the scenario. Selectively activating rules in this manner can significantly increase the efficiency of the test oracle 252.

The activation or deactivation of a given rule may be dependent on the activation/deactivation of one or more other rules. For example, an “optimal comfort” rule may be deemed inapplicable when the pedestrian emergency braking rule is activated (because the pedestrian's safety is the primary concern), and the former may be deactivated whenever the latter is active.

Rule evaluation logic 424 evaluates each active rule for any time period(s) it remains active. Each interactive rule is evaluated in a pairwise fashion between the ego agent and any other agent to which it applies.

There may also be a degree of interdependency in the application of the rules. For example, another way to address the relationship between a comfort rule and an emergency braking rule would be to increase a jerk/acceleration threshold of the comfort rule whenever the emergency braking rule is activated for at least one other agent.

Whilst pass/fail results have been considered, rules may be non-binary. For example, two categories for failure—“acceptable” and “unacceptable”—may be introduced. Again, considering the relationship between a comfort rule and an emergency braking rule, an acceptable failure on a comfort rule may occur when the rule is failed but at a time when an emergency braking rule was active. Interdependency between rules can, therefore, be handled in various ways.

The activation criteria for the rules 254 can be specified in the rule creation code provided to the rule editor 400, as can the nature of any rule interdependencies and the mechanism(s) for implementing those interdependencies.

### Graphical User Interface

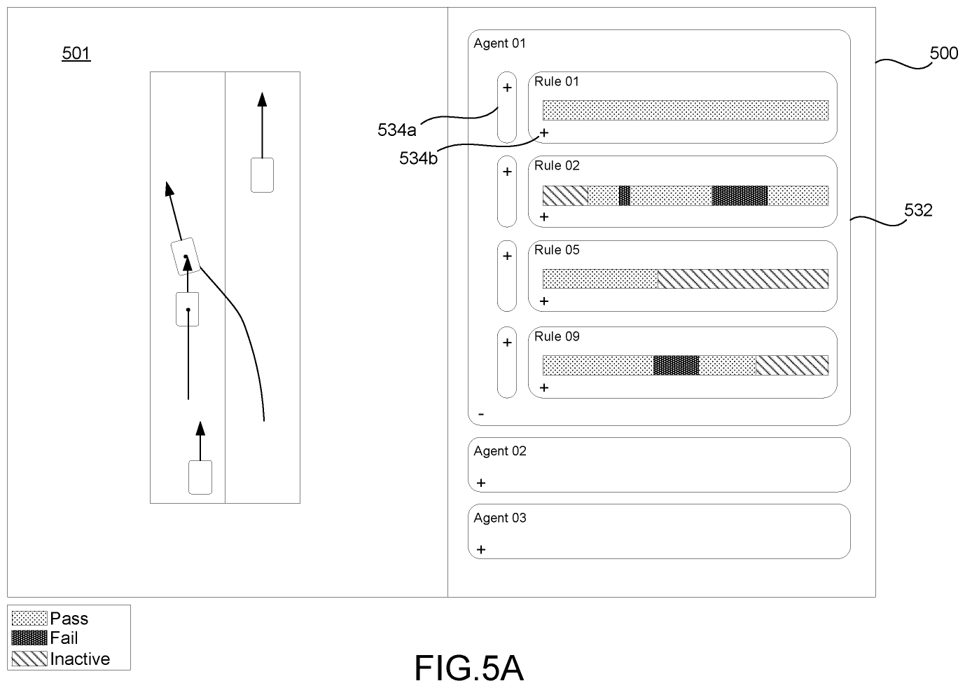

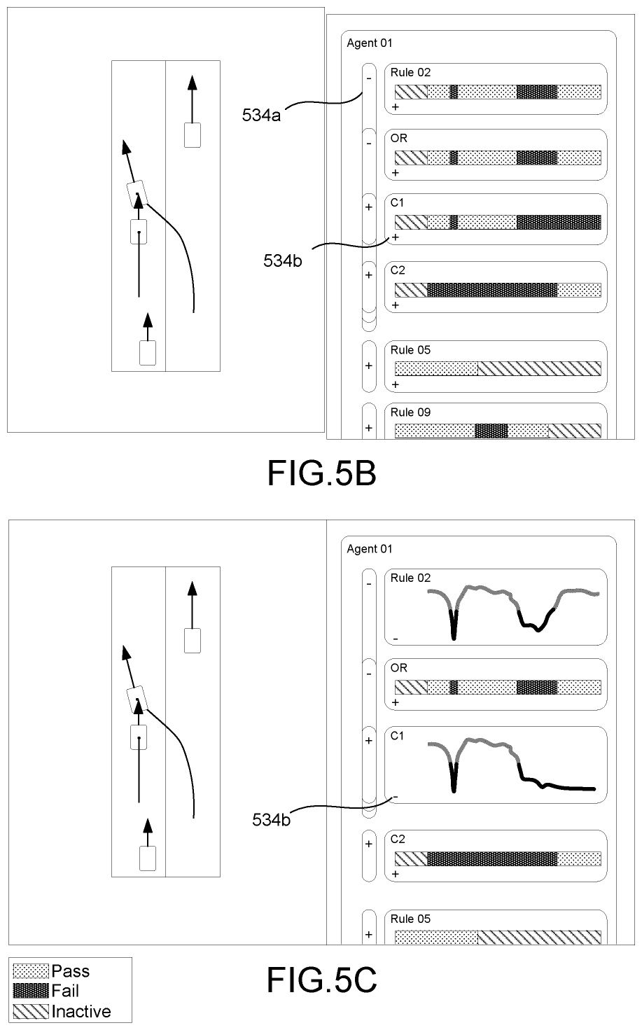

FIG. 5 shows a schematic block diagram of a visualization component 520. The visualization component is shown having an input connected to the test database 258 for rendering the outputs 256 of the test oracle 252 on a graphical user interface (GUI) 500. The GUI is rendered on a display system 522.

FIG. 5A shows an example view of the GUI 500. The view pertains to a particular scenario containing multiple agents. In this example, the test oracle output 526 pertains to multiple external agents, and the results are organized according to agent. For each agent, a time-series of results is available for each rule applicable to that agent at some point in the scenario. In the depicted example, a summary view has been selected for “Agent 01”, causing the “top-level” results computed to be displayed for each applicable rule. There are the top-level results computed at the root node of each rule tree. Colour coding is used to differentiate between periods when the rule is inactive (‘not applicable’) for that agent, active and passes, and active and failed.

A first selectable element 534a is provided for each time-series of results. This allows lower-level results of the rule tree to be accessed, i.e. as computed lower down in the rule tree.

FIG. 5B shows a first expanded view of the results for “Rule 02”, in which the results of lower-level nodes are also visualized. For example, for the “safe distance” rule of FIG. 4B, the results of the “is_latd_safe node” and the “is_lond_safe” nodes may be visualized (labelled “C1” and “C2” in FIG. 5B). In the first expanded view of Rule 02, it can be seen that success/failure on Rule 02 is defined by a logical OR relationship between results C1 and C2; Rule 02 is failed only when failure is obtained on both C1 and C2 (as in the “safe distance” rule above).

A second selectable element 534b is provided for each time-series of results, that allows the associated numerical performance scores to be accessed.

FIG. 5C shows a second expanded view, in which the results for Rule 02 and the “C1” results have been expanded to reveal the associated scores for time period(s) in which those rules are active for Agent 01. The scores are displayed as a visual score-time plot that is similarly colour coded to denote pass/fail.

### Example Scenarios:

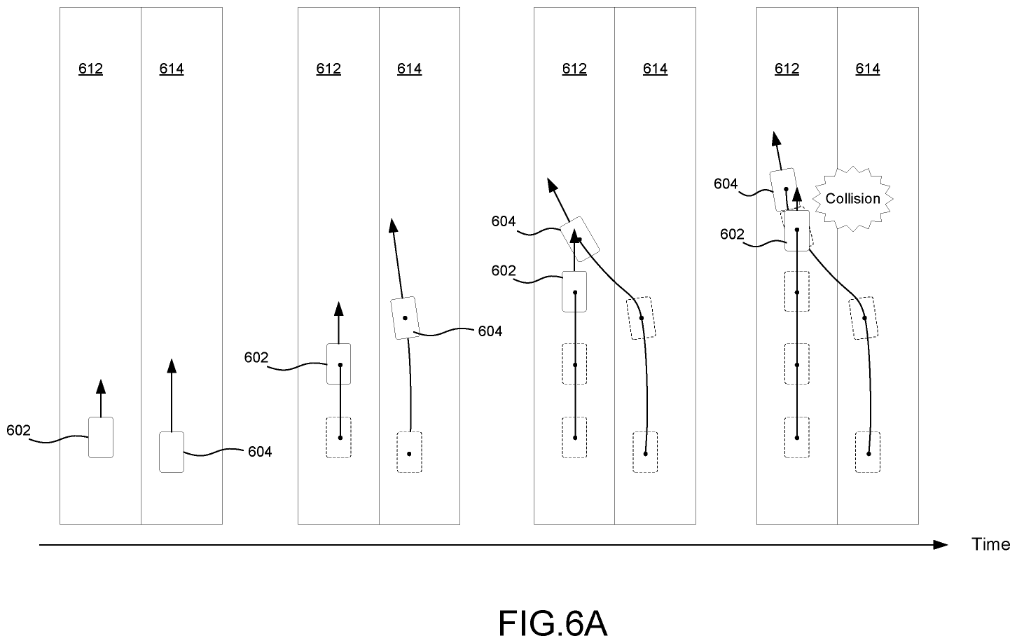

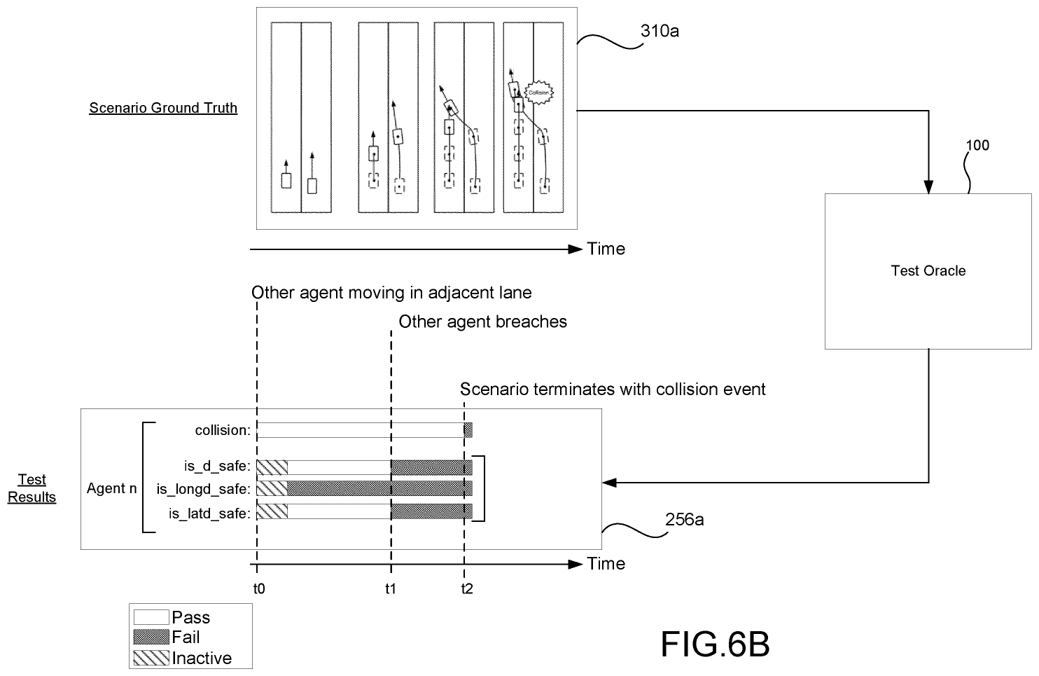

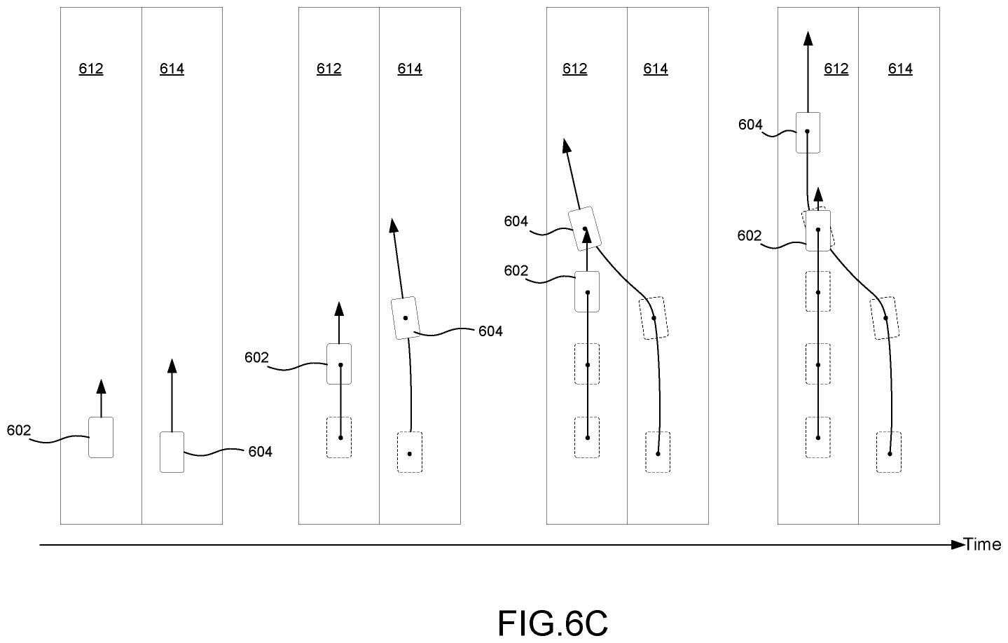

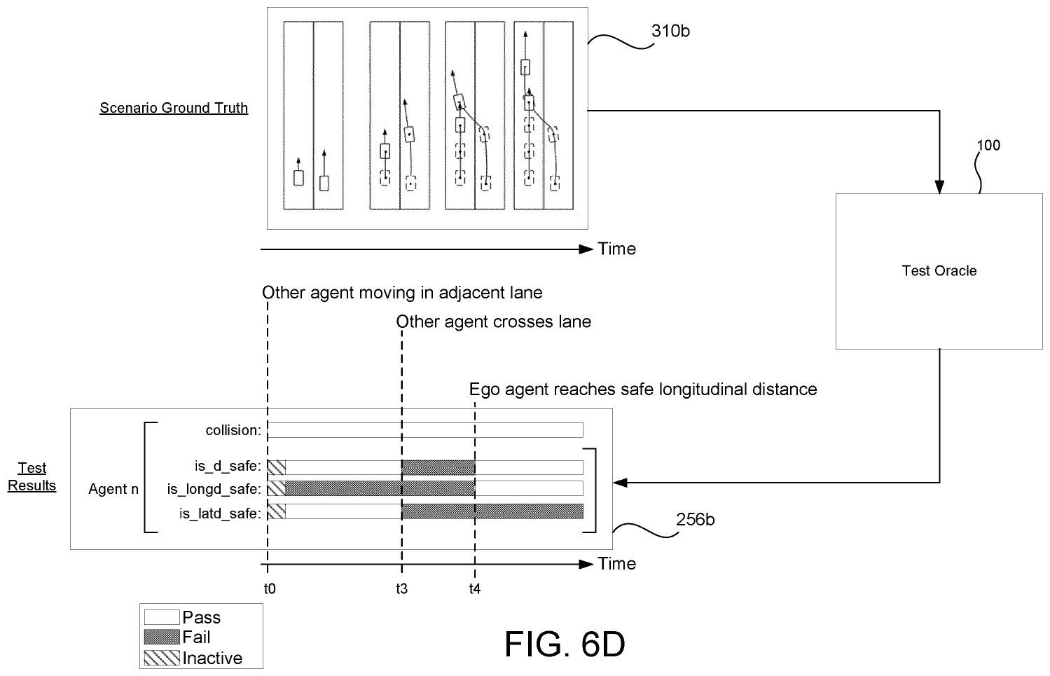

FIG. 6A depicts a first instance of a cut-in scenario in the simulator 202 that terminates in a collision event between an ego vehicle 602 and another vehicle 604. The cut-in scenario is characterized as a multi-lane driving scenario, in which the ego vehicle 602 is moving along a first lane 612 (the ego lane) and the other vehicle 604 is initially moving along a second, adjacent lane 604. At some point in the scenario, the other vehicle 604 moves from the adjacent lane 614 into the ego lane 612 ahead of the ego vehicle 602 (the cut-in distance). In this scenario, the ego vehicle 602 is unable to avoid colliding with the other vehicle 604. The first scenario instance terminates in response to the collision event.

FIG. 6B depicts an example of a first oracle output 256a obtained from ground truth 310a of the first scenario instance. A “no collision” rule is evaluated over the duration of the scenario between the ego vehicle 602 and the other vehicle 604. The collision event results in failure on this rule at the end of the scenario. In addition, the “safe distance” rule of FIG. 4B is evaluated. As the other vehicle 604 moves laterally closer to the ego vehicle 602, there comes a point in time (t1) when both the safe lateral distance and safe longitudinal distance thresholds are breached, resulting in failure on the safe distance rule that persists up to the collision event at time t2.

FIG. 6C depicts a second instance of the cut-in scenario. In the second instance, the cut-in event does not result in a collision, and the ego vehicle 602 is able to reach a safe distance behind the other vehicle 604 following the cut in event.

FIG. 6D depicts an example of a second oracle output 256b obtained from ground truth 310b of the second scenario instance. In this case, the “no collision” rule is passed throughout. The safe distance rule is breached at time t3 when the lateral distance between the ego vehicle 602 and the other vehicle 604 becomes unsafe. However, at time t4, the ego vehicle 602 manages to reach a safe distance behind the other vehicle 604. Therefore, the safe distance rule is only failed between time t3 and time t4.

### Rule Editor—Domain Specific Language (DSL)

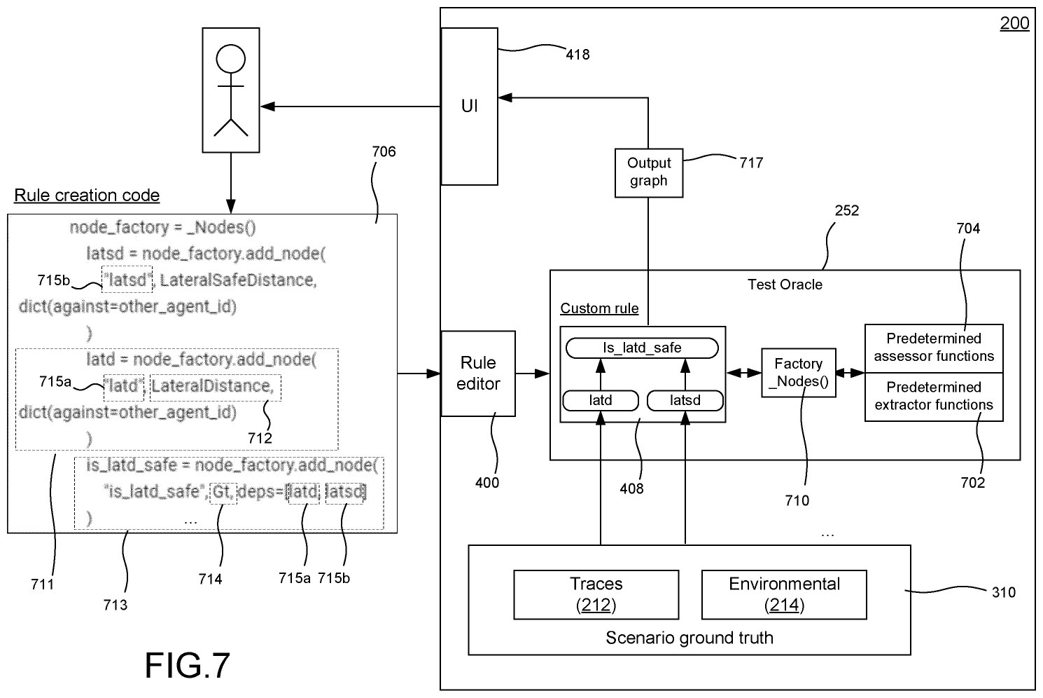

FIG. 7 shows an example of rule creation inputs to the test oracle 400 that are coded in a particular choice of DSL.

In the example of FIG. 7, custom rule graphs can be constructed within the testing platform 200. The test oracle 252 is configured to provide a set of modular “building blocks”, in the form of predetermined extractor functions 702 and predetermined assessor functions 704.

The rule editor 400 receives rule creation inputs from a user. The rule creation inputs are coded in the DSL, and an example section of rule creation code 706 is depicted. The rule creation code 706 defines a custom rule graph 408, corresponding to that of FIG. 4A. The choice of rule gram is purely illustrative, and a benefit of the DSL is that desired rule graph can be constructed by the user in a bespoke fashion. The rule editor 400 interprets the rule creation code 706 and causes the custom rule graph 408 to be implemented within the test oracle 252.

Within the code 706, an extractor node creation input is depicted and labelled 711. The extractor node creation input 711 is shown to comprise an identifier 712 of one of the predetermined extractor functions 702.

An assessor node creation input 713 is also depicted, and is shown to comprise an identifier 714 of one of the predetermined assessor functions 704. Here, the input 713 instructs an assessor node to be created with two child nodes, having node identifiers 715a, 715b (which happen to be extractor nodes in this example, but could be assessor nodes, extractor nodes or a combination of both in general).

The nodes of the custom rule graph are objects in the object-oriented programming (OOP) sense. A node factory class (Nodes( )) is provided within the test oracle 252. To implement the custom rule graph 708, the node factory class 710 is instantiated, and a node creation function (add node) of a resulting factory object 710 (node-factory) is called with the details of the node to be created.

According to the code 706, a Gt function is to be used to implement a safe lateral distance rule between an ego agent and another agent in the scenario (having agent identifier “other_agent_id”). Two extractor nodes (latd, latsd) are defined in the code 406, and mapped to predetermined LateralDistance and LateralSafeDistance extractor functions respectively. Those functions operate directly on the scenario ground truth 310 to extract, respectively, a time-varying lateral distance signal (measuring a lateral distance between the ego agent and the identified other agent), and a time-varying safe lateral distance signal for the ego agent and the identified other agent. The safe lateral distance signal could depend on various factors, such as the speed of the ego agent and the speed of the other agent (captured in the traces 212), and environmental conditions (e.g. weather, lighting, road type etc.) captured in the contextual data 214. This is largely invisible to an end-user, who simply has to select the desired extractor function (although, in some implementations, one or more configurable parameters of the function may be exposed to the end-user).

An assessor node (is_latd_safe) is defined in the code 706 as a parent to the latd and latsd extractor nodes, and is mapped to the Gt atomic predicate. Accordingly, when the rule tree 408 is implemented, the is_latd_safe assessor node applies the Gt function to the outputs of the latd and latsd extractor nodes, in order to compute a true/false result for each timestep of the scenario, returning TRUE for each time step at which the latd signal exceeds the latsd signal and FALSE otherwise. In this manner, a “safe lateral distance” rule has been constructed from atomic extractor functions and predicates; the ego agent fails the safe lateral distance rule when the lateral distance reaches or falls below the safe lateral distance threshold. As will be appreciated, this is a very simple example of a custom rule. Rules of arbitrary complexity can be constructed according to the same principles. The test oracle 252 applies the custom rule tree 408 to the scenario ground truth 310, and provides the results in the form of an output graph 717—that is to say, the test oracle 252 does not simply provide top-level outputs, but provides the output computed at each node of the custom rule graph 408. In the “safe lateral distance example”, the time-series of results computed by the is_latd_safe node are provided, but the underlying signals latd and latsd are also provided in the output graph 717, allowing the end-user to easily investigate the cause of a failure on a particular rule at any level in the graph. In this example, the output graph 717 is a visual representation of the custom rule graph 408 that is displayed via a user interface (UI) 418; each node of the custom rule graph is augmented with a visualization of its the output, in the manner depicted in FIGS. 5A-C.

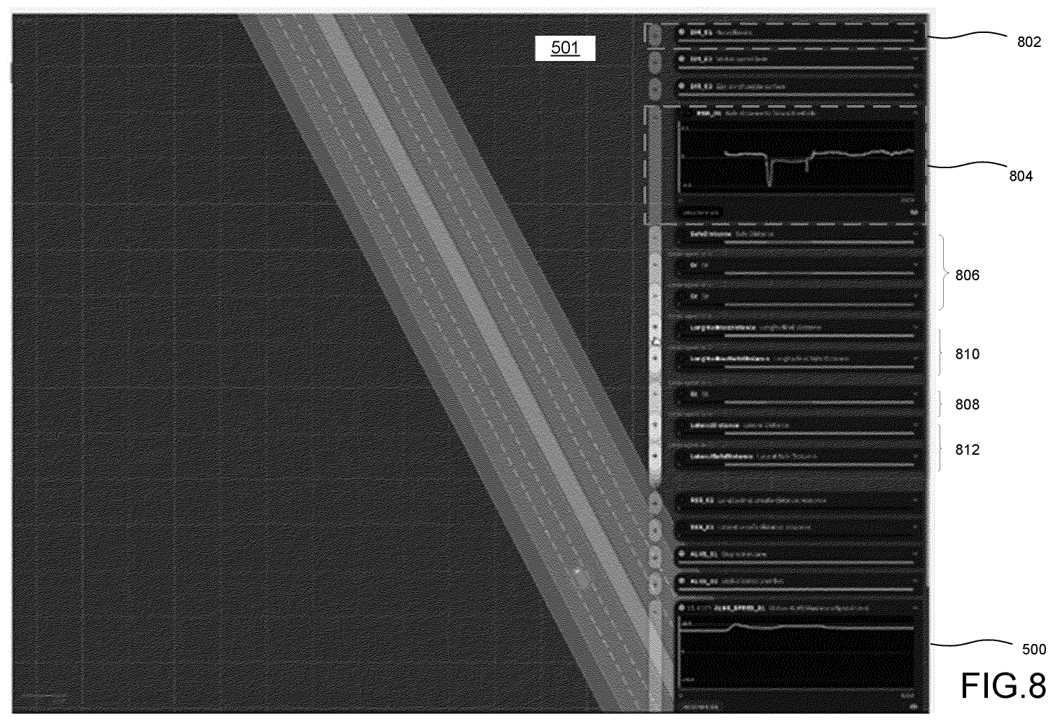

FIG. 8 shows a further example view of the GUI 500 for rendering a custom rule tree. Multiple output graphs are available via the GUI, displayed in association with a visualization 501 of the scenario ground truth to which the output graph relates. Each output graph is a visual representation of a particular rule graph that has been augmented with a visualization of the output of each node of the rule graph. Each output graph is initially displayed in a collapsed form, with only the root node of each computation graph represented. First and second visual elements 802, 804 represent the root nodes of first and second computational graphs respectively. The first output graph is depicted in a collapsed form, and only the time-series of binary pass/fail results for the root node is visualized (as a simple colour-coded horizontal bar within the first visual element 802). However, the first visual element 802 is selectable to expand the visualization to lower-level node(s) and their output(s). The second output graph is depicted in an expanded form, accessed by selecting the second visual element 804. Visual elements 806, 808 represent lower-level assessor nodes within the applicable rule graph, and their results are visualized in the same way. Visual elements 810, 812 represent extractor nodes within the graph. The visualization of each node is also selectable to render an expanded view of that node. The expanded view provides a visualization of the time-varying numerical signal computed or extracted at that node. The second visual element 804 is shown in an expanded state, with a visualization of its derived signal displayed in place of its binary sequence of results. The derived signal is colour-coded based on the failure threshold (the signal dropping to zero or below denotes failure on the applicable rule in the present example). The visualizations 810, 812 of the extractor nodes are expandible in the same way to render visualizations of their raw signals. The view of FIG. 8 renders the outputs of a rule graph once it has been evaluated on a given set of scenario ground truth. Additionally, an initial visualization may be rendered for the benefit of the user creating the rule graph, prior to its evaluation. The initial visualization may be updated responses to change in the rule creation code 406.

Although not depicted in FIG. 7, a node creation input 711, 713 may additionally set value(s) for one or more configurable parameter(s) (such as thresholds, time intervals etc.) of the associated assessor or extractor function.

In certain embodiments, increased computational efficiency may be achieved via selective evaluation of a rule graph. For example, within the graph of FIG. 7, if (for example) the is_latd_safe returns TRUE at some time step or time interval, the output of the top-level is_d_safe node can be computed without evaluating the longitudinal distance branch for that time step/interval. Such efficiency gains are based on “top-down” evaluation of the graph—starting at the top-level of the tree, and only computing branche(s) down to the extractor nodes as needed to obtain the to-level output.

An assessor or extractor function may have one or more configurable parameters. For example, the latsd and lonsd nodes may have configurable parameter(s) that specify how the threshold distances are extracted from the scenario ground truth 310, e.g. as configurable functions of ego velocity.

Further efficiency gains can be obtained by caching and reusing results to the extent possible.

For example, when a user modifies the graph or some parameter, only the outputs of affected nodes may be recomputed (and, in some cases, only to the extent necessary to compute the top-level result—see above).

Whilst the above examples consider outputs in the form of time-varying signals and or time-series of categorical (e.g. PASS/FAIL or TRUE/FALSE results), other types of output can, alternatively or additionally, be passed between nodes. For example, time-varying iterables (i.e. objects that can be iterated over a for loop), may be passed between nodes.

Variables may be assigned and/or passed through the tree and bound at runtime. The combination of runtime variables and iterables provides control of loops and runtime (scenario-relevant) parameterisation, whilst the tree itself remains ‘static’.

For loops can define scenario-specific conditions under which rules apply, for example “for agents in front” or “for each traffic light at this junction” etc. To implement such loops, variables are needed (e.g. to implement the loop ‘for each nearby agent’ based on an ‘other_agent’ variable) but can also be used to define (store) variables in a current context which can then be accessed (loaded) by other blocks (nodes) further below in the tree.

Time periods may only be computed as required (also in a top-down manner), and results may be cached and merged for newly required time periods.

For example, one rule (rule graph) might require an acceleration to be computed for a forward vehicle to check against an adaptive cruise control headway. Separately, another rule (rule tree) might require the acceleration of all vehicles around the ego agent (‘nearby’ agents).

Where the applicable time periods overlap, one tree may be able to re-use the other's acceleration data (e.g. in the case that the duration for which an ‘other_vehicle’ is considered ‘forward’ is a subset of the duration for which it is considered ‘nearby’).

Referring to FIG. 4C, the rule activation logic 422 may be implemented based on loops over iterables, in the manner described above, as a scenario run progresses. The DSL can be extended to implement loops over arbitrary predicates, at any given time step. In this case, a first logic predicate defines an activation condition applicable to each agent. For example, the first predicate might define the concept of a “nearby” agent in terms of a distance threshold condition (e.g. satisfied by any agent(s) within some threshold distance of the ego agent), or the concept of a “forward” agent as an appropriate set of conditions on agent position (e.g. satisfied by a single agent if that agent is (i) in front of the ego agent, (ii) in the same lane as the ego agent, and (iii) closer to the agent than any other agent satisfying conditions (i) and (ii)). The first logic predicate, defining the activation condition, can be coded in DSL in the same way as the rules themselves. A rule tree can, in turn, be defined by a second logic predicate, in the manner above. This extends the DSL framework to incorporate loops over arbitrary predicates. Rules and activation conditions to be encoded in DSL using loops of the form “for [any agent satisfying predicate 1], evaluate [predicate 2]” to be constructed in DSL; at each step of the scenario run, the set of agent(s) satisfying predicate 1 (if any) is constructed, and predicate 2 is evaluated for the members of that set only. “Predicate 1” defines the activation condition for the rule, per agent, and “predicate 2” defines the rule tree itself. A time-varying iterable can be constructed to track which agents satisfy predicate 1 at any time over the duration of a scenario run, and passed down the rule tree as needed to facilitate efficient rule evaluation.

Each rule and its activation condition may, for example, be defined in first-order logic.

Below, a section of code is provided that defines a custom rule graph (ALKS_01) as a temporal logic predicate, using an alternative syntax.

```
safety rule ALKS_01: “ALKS headway ACC”
description “EGO respect headway in absence of cut-in.”
ForEachAgent
  (
  agents = NearbyAgents( ),
  block =
    (
    LongitudinalDistance( ) > LookupTable(table = HEADWAY_LUT,
    source VelocityAlongRoadLongitudinalAxis( ))
    and
    Next(a=LongitudinalDistance( ) < LookupTable(table =
    HEADWAY_LUT, source = VelocityAlongRoadLongitudinalAxis(
    )))
    and
    AgentIsOnSameLane( )
    )
  =>
  Eventually
    (a = not(Always(a = OtherAgent(a=VelocityAlongRoadLateralAxis(
    )) > MIN_NOTICEABLE_LATERAL_VELOCITY,
    upper_bound_sec =
    LANE_INTRUSION_LATERAL_MOVEMENT_MIN_TIME)
    and Eventually(a = AgentIsOnClosestOffsideLane( ) and
    OtherAgent(a=DistanceToLaneEdgeNearside( )) <
    ALKS_LANE_INTRUSION_DISTANCE,
    upper_bound_sec =
    LANE_INTRUSION_LATERAL_MOVEMENT_MIN_TIME))
    and
    Next
      (a = Always(a= OtherAgent(a=VelocityAlongRoadLateralAxis(
      )) > MIN_NOTICEABLE_LATERAL_VELOCITY,
      upper_bound_sec =
      LANE_INTRUSION_LATERAL_MOVEMENT_MIN_TIME)
      and
      Eventually(a=AgentIsOnClosestOffsideLane( ) and
      OtherAgent(a=DistanceToLaneEdgeNearside( )) <
      ALKS_LANE_INTRUSION_DISTANCE, upper_bound_sec =
      LANE_INTRUSION_LATERAL_MOVEMENT_MIN_TIME)
      ),
    upper_bound_sec =
    LANE_INTRUSION_LATERAL_MOVEMENT_MIN_TIME
    )
  )
```

In the above example, LongitudinalDistance( ) and Velocity AlongRoadLateralAxis( ) are predetermined extractor functions, and functions such as “and”, Eventually( ), Next( ) and Always( ) are atomic assessor functions. The function AgentIsOnSameLane( ) is an assessor function applied directly to the scenario that determined whether a given agent is in the same lane as the ego agent.

Here, NearbyAgents( ) is time-varying iterable identifying any other agents that satisfy some distance threshold to the ego agent. This is one example of a rule activation condition applied between an ego agent and each other agent based on distance from the ego agent.

Whilst the above examples consider AV stack testing, the techniques can be applied to test components of other forms of mobile robot. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack FIG. 1 may be implemented in programmable or dedicated processor(s), or a combination of both, on-board a vehicle or in an off-board computer system in the context of testing and the like. The various components of FIG. 2, such as the simulator 202 and the test oracle 252 may be similarly implemented in programmable and/or dedicated hardware.

1. A computer-implemented method of evaluating the performance of a trajectory planner for a mobile robot in a real or simulated scenario, the method comprising:
receiving scenario ground truth of the scenario, the scenario ground truth generated using the trajectory planner to control an ego agent of the scenario responsive to at least one scenario element of the scenario;
receiving one or more performance evaluation rules for the scenario and at least one activation condition for each performance evaluation rule; and
processing, by a test oracle, the scenario ground truth, to determine whether the activation condition of each performance evaluation rule is satisfied over multiple time steps of the scenario, wherein each performance evaluation rule is evaluated by the test oracle, to provide at least one test result, only when its activation condition is satisfied.

2. The method of claim 1, wherein the scenario ground truth is processed to determine whether the activation condition of each performance evaluation rule is satisfied over multiple time steps of the scenario for each scenario element of a set of multiple scenario elements, wherein each performance evaluation rule is evaluated only when its activation condition is satisfied for at least one of the scenario elements, and only between the ego agent and the scenario element(s) for which the activation condition is satisfied.

3. The method of claim 1, wherein each performance evaluation rule is encoded in a piece of rule creation code as a second logic predicate and its activation condition is encoded in the piece of rule creation code as a first logic predicate, wherein at each time step, the test oracle evaluates the first logic predicate for each scenario element, and only evaluates the second logic predicate between the ego agent and any scenario element satisfying the first logic predicate.

4. The method of claim 1, wherein multiple performance evaluation rules, having different respective activation conditions, are received and selectively evaluated by the test oracle according to their different respective activation conditions.

5. The method of claim 1, wherein each performance evaluation rule pertains to driving performance.

6. The method of claim 1, comprising:
rendering on a graphical user interface (GUI) respective results for the multiple time steps in a time-series, the result at each time step visually indicating one category of at least three categories comprising:
a first category when the activation condition is not satisfied,
a second category when the activation condition is satisfied and the rule is passed, and
a third category when the activation condition is satisfied and the rule is failed.

7. The method of claim 6, wherein the result is rendered as one colour of at least three different colours corresponding to the at least three categories.

8. The method of claim 1, wherein the activation condition of a first performance evaluation rule of the performance evaluation rules is dependent on the activation condition of at least a second performance evaluation rule of the performance evaluation rules.

9. The method of claim 8, wherein the first performance evaluation rule is deactivated when the second performance evaluation rule is active.

10. The method of claim 9, wherein the second performance evaluation rule pertains to safety and the first performance evaluation rule pertains to comfort.

11. The method of claim 1, wherein the scenario elements comprise one or more other agents.

12. The method of claim 11, wherein the set of scenario elements is a set of other agents.

13. The method of claim 11, wherein the scenario ground truth is processed to determine whether the activation condition of each performance evaluation rule is satisfied over multiple time steps of the scenario for each scenario element of a set of multiple scenario elements, wherein each performance evaluation rule is evaluated only when its activation condition is satisfied for at least one of the scenario elements, and only between the ego agent and the scenario element(s) for which the activation condition is satisfied, and
wherein the activation condition is evaluated for each scenario element to compute, at each time step, an iterable containing identifier of any scenario elements for which the activation condition is satisfied, the performance evaluation rule being evaluated by looping over the iterable at each time step.

14. The method of claim 13, wherein the performance evaluation rule is defined as a computational graph applied to one or more signals extracted from the scenario ground truth, the iterable being passed through the computational graph in order to evaluate the rule between the ego agent any scenario element satisfying the activation condition.

15. A computer system for evaluating the performance of a trajectory planner for a mobile robot in a real or simulated scenario, the computer system comprising:
at least one memory configured to store computer-readable instructions; and
at least one hardware processor coupled to the at least one memory and configured to execute the computer-readable instructions, which upon execution cause the at least one hardware processor to implement operations comprising:
receive scenario ground truth of the scenario, the scenario ground truth generated using the trajectory planner to control an ego agent of the scenario responsive to at least one scenario element of the scenario;
receive one or more performance evaluation rules for the scenario and at least one activation condition for each performance evaluation rule; and
process, by a test oracle, the scenario ground truth, to determine whether the activation condition of each performance evaluation rule is satisfied over multiple time steps of the scenario, wherein each performance evaluation rule is evaluated by the test oracle, to provide at least one test result, only when its activation condition is satisfied.

16. A non-transitory computer readable medium embodying computer program instructions, the computer program instructions configured so as, when executed on one or more hardware processors, to implement operations comprising:
receiving scenario ground truth of the scenario, the scenario ground truth generated using the trajectory planner to control an ego agent of the scenario responsive to at least one scenario element of the scenario;
receiving one or more performance evaluation rules for the scenario and at least one activation condition for each performance evaluation rule; and
processing, by a test oracle, the scenario ground truth, to determine whether the activation condition of each performance evaluation rule is satisfied over multiple time steps of the scenario, wherein each performance evaluation rule is evaluated by the test oracle, to provide at least one test result, only when its activation condition is satisfied.
